(19) United States
(12) Patent Application Publication
(10) Pub. No.: US 2005/0238956 A1
(43) Pub. Date: Oct. 27, 2005

(54) Negative electrode for lithium battery and lithium battery comprising same

(75) Inventor: Jea-Woan Lee, Suwon-city (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-city (KR)

(21) Appl. No.: 10/691,476

(22) Filed: Oct. 23, 2003

(30) Foreign Application Priority Data
Oct. 25, 2002 (KR) 2002-65484

(51) Int. Cl. H01M 2/26; H01M 4/40

(52) U.S. Cl. 429/211; 429/231.95

(57) ABSTRACT

The present invention relates to a negative electrode for a lithium battery, and a lithium battery including the same. A negative electrode for a lithium battery includes a metallic lithium plate and a negative electrode tab attached to a surface of the metallic lithium plate, wherein an average surface roughness of the metallic lithium plate on an area attached to the negative tab is 0.1 to 5 μm; a negative electrode for a lithium battery including a metallic lithium plate and a negative electrode tab having a porosity of 50 to 100% and being attached to the metallic lithium plate; a negative electrode for a lithium battery including a metallic lithium plate and a negative electrode tab attached to both the upper and lower end surfaces of the metallic lithium plate; or a negative electrode for a lithium battery including a metallic lithium plate and a negative electrode tab attached to the surfaces of the metallic lithium plate, wherein the surface area of the negative electrode tab to be attached to the metallic lithium plate is 10% larger than the geographical area.

### CROSS-REFERENCE TO RELATED APPLICATIONS

This application claims priority of Korean Patent Application No. 2002-65484 filed in the Korean Intellectual Property Office on Oct. 25, 2002, the disclosure of which is incorporated herein by reference.

### BACKGROUND OF THE INVENTION

1. Field of the Invention

The present invention relates to a negative electrode for a lithium battery and a lithium battery comprising the same, and more particularly, to a negative electrode for a lithium battery capable of enhancing capacity characteristics and decreasing the occurrence of a short therein, and a lithium battery comprising the same.

2. Description of the Related Art

As portable electronic products become more minute in size and lighter in weight, demands for development of batteries exhibiting higher performance and higher capacity have rapidly increased. Generally, batteries are divided into primary (non-rechargeable) and secondary (rechargeable) batteries, depending on their capability of being electrically recharged. The primary battery may include, for example, a manganese battery, an alkaline battery, a mercury battery, a silver oxide battery, and so on. The secondary battery may include, for example, a lead battery, an Ni-MH (nickel-metal hydride) battery, a sealed nickel-cadmium battery, a metallic lithium battery, a lithium ion battery, a lithium polymer battery, a lithium-sulfur battery, and so on.

Batteries are electrochemical devices that convert chemical energy into electrical energy by electrochemical oxidation and reduction reactions between a positive and a negative electrode. The active materials participating in the electrochemical reaction between these two electrodes influence the reliability and the performance factors of the battery such as capacity, cycle life, and voltage.

Lithium is an attractive material among currently used active materials since lithium has a high electric capacity per unit of weight and high electronegativity, capable of imparting high capacity and a high voltage to a battery. When employing metallic lithium as a negative active material, the metallic lithium can be used both as the active material and as a current collector at the same time. The metallic lithium plate is thus used as a negative electrode plate by itself, without adding a current collector.

FIG. 1 shows a structure of a non-aqueous lithium battery 1. The battery is fabricated by interposing a separator 6 between a positive electrode 2 and a negative electrode 4, winding them to form an electrode group 8, and inserting the electrode group into a case 10. The upper side of the battery case 10 is then sealed with a battery cover 12 and a gasket 14, and a safety vent (not shown) may be installed in the battery cover 12 to permit the escape of gases. The outer surface of the battery cover 12 acts as a positive electrode pole, while the outer surface of the case 10 acts as a negative electrode pole. The positive electrode tab 16 and the negative electrode tab 18 are connected so that the electrodes are associated with the poles. Insulators 20, 22 are placed inside the battery to prevent the occurrence of a short, and electrolyte 24 is injected therein prior to sealing the battery by clamping the cover 12 on the case 10.

When the negative electrode plate is a metallic lithium negative electrode and the battery case is made of a metallic material, the metallic lithium negative electrode would be directly connected to the battery case conducting electricity there between. This, however, could cause a problem in that the electric conductivity is degraded between the outer surface of the battery case and the metallic lithium since the metallic lithium tends to react with electrolytes. Meanwhile, when the battery case is not made of metallic materials, it is necessary to take the pole outside of the battery, and accordingly, the negative electrode tab should be made of materials that are not dissolved and eluted in the electrolyte.

Nowadays, electric devices such as portable phones require a pouch-type battery since they are lighter in weight, higher in capacity, and rectangular in shape. The lithium is known to have a high capacity per unit of weight, so that it is becoming attractive as a negative active material. In addition to this tendency, methods for electrically connecting with the battery pole where employing the metallic lithium as a negative electrode are being vigorously studied.

Japanese Patent Laid-Open Publication No. P5-251073 discloses a method of preventing the edge of a nickel tab from damaging the separator, and a method of decreasing the occurrence of a short by covering the nickel tab with the metallic lithium in such a manner that the nickel tab is stacked on the lithium foil and the lithium is further stacked thereon. This method, however, causes a problem in that the effective capacity of the battery is decreased by as much as the space occupied by the lithium covering the nickel tab.

### SUMMARY OF THE INVENTION

The above and/or other aspects of present invention are achieved by providing a negative electrode for a lithium battery having a high capacity as well as an excellent attaching strength between a metallic lithium negative electrode and a negative electrode tab.

Another aspect of present invention is to provide a method of fabricating a negative electrode for a lithium battery having a high capacity and an excellent attaching strength between a metallic lithium negative electrode and a negative electrode tab.

In order to achieve the above and/or other aspects objects, the present invention provides a negative electrode for a lithium battery, comprising a metallic lithium plate and a negative electrode tab attached to the surface of the metallic lithium plate, wherein an average surface roughness (Ra) of the metallic lithium plate on an area attached to the negative electrode tab is 0.1 to 5 μm.

The present invention also provides a negative electrode for a lithium battery, comprising a metallic lithium plate and a negative electrode tab attached to the metallic lithium plate, wherein the negative electrode tab has a porosity of 50 to 100%.

The present invention further provides a negative electrode for a lithium battery, comprising a metallic lithium plate and a negative electrode tab attached to both the upper and lower end surfaces of the metallic lithium plate.

The present invention further provides a negative electrode for a lithium battery, comprising a metallic lithium plate and a negative electrode tab attached to the surface of metallic lithium plate, wherein the surface of negative electrode tab that is attached to the metallic lithium plate has a surface area of 10% larger than a geographical area.

The present invention further provides a method of fabricating a negative electrode for a lithium battery, comprising brushing the surface area of a metallic lithium plate to be attached to a negative electrode tab so that the average surface roughness (Ra) of the surface area is 0.1 to 5 μm, and pressing the negative electrode tab onto the metallic lithium plate and attaching the negative electrode tab with the metallic lithium plate.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows a cross-sectional view of a lithium battery.

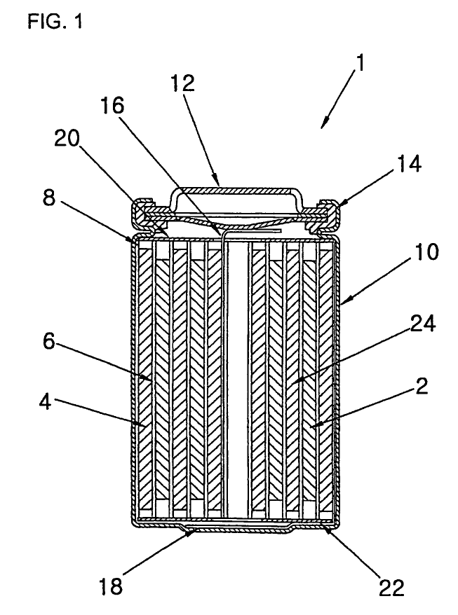

### DETAILED DESCRIPTION OF THE PREFERRED EMBODIMENTS

Reference will now be made in detail to the embodiments of the present invention, examples of which are illustrated in the accompanying drawing, wherein like reference numerals refer to the like elements throughout. The embodiments are described below to explain the present invention by referring to the figure.

According to a first embodiment of the present invention, a negative electrode for a lithium secondary battery comprises a metallic lithium plate and a negative electrode tab attached to the surface of the metallic lithium plate, wherein an average surface roughness (Ra) of the metallic lithium plate at the area attached to the negative tab is 0.1 to 5 μm.

The metallic lithium plate is preferably a metallic lithium foil or metallic lithium coated on a conductive substrate. Examples of the conductive substrate include a metal foil, a metal film, a conductive polymer film, and a polymer film deposited with a metal. The metal foil and the metal film may be composed of copper or nickel. The term “polymer film deposited with a metal” means that any metal such as copper or nickel is deposited on a polymer film. The polymer film may be composed of polyacetylene, polypyrrole, polyaniline, polythiopene, poly(p-phenylene), poly(phenylene vinylene), polyazulene, poly(perinaphthalene), poly(naphthalene-2,6-diyl), polyacene, and so on.

The negative electrode tab is preferably made of a metal plate or a metal foam having a thickness of 10 to 50 μm. The metal plate and the metal foam may be composed of nickel, copper, iron, stainless steel, and so on. The average surface roughness (Ra) is preferably in a range of 0.1 to 5 μm and more preferably 0.3 to 0.6 μm. When the roughness is less than 0.1 μm, the negative electrode tab cannot be firmly attached to the plate, while when the roughness is more than 5 μm, the electrode plate becomes damaged or the tab breaks and gets disconnected during the brushing process.

A sheet-type negative electrode tab is stacked on the surface of the metallic lithium plate which has the aforementioned range of roughness, and then the tab is pressed to impart a firm attachment to the plate. However, the method of attaching the negative electrode tab to the negative electrode plate is not limited to pressing.

According to a second embodiment of the present invention, the negative electrode for a lithium battery comprises a metallic lithium plate and a negative electrode tab attached to the metallic lithium plate, wherein the negative electrode tab has a porosity of 50 to 100%.

The metallic lithium plate is a metallic lithium foil or metallic lithium coated on a conductive substrate, which are identical to those in the first embodiment.

The negative electrode tab is in a form of foam, and has a porosity of 50 to 100% and preferably 80 to 95%. When the negative electrode tab is made of a foam having a porosity within this range, the welding of the negative electrode tab to the metallic lithium plate is effectively performed since the lithium is pressed and incorporated into the void of the foam or melted and coagulated into the void of the foam.

The foam negative electrode tab is stacked on the surface of the metallic lithium plate, followed by pressing to obtain the firm attachment of the negative electrode tab to the negative electrode plate.

According to a third embodiment, the negative electrode for a lithium battery comprises a metallic lithium plate, and a negative electrode tab attached to both upper and lower end surfaces of the metallic lithium plate.

The metallic lithium plate is preferably a metallic lithium foil or metallic lithium coated on a conductive substrate, which are identical to those in the first embodiment.

The negative electrode tab may be a metal foil or a metal foam. The negative electrode tab may be composed of, but is not limited to, nickel, copper, iron, stainless steel, and so on. An upper tab and a lower tab are placed parallel with each other on both end surfaces of the metallic lithium plate, and the upper tab is welded to the lithium and the lower tab is welded to the lithium.

According to a fourth embodiment of the present invention, a negative electrode for a lithium battery comprises a metallic lithium plate and a negative electrode tab attached to the surface of the metallic lithium plate, wherein the surface of the negative electrode tab that is attached to the metallic lithium plate has a surface area 10% larger than a geographical area.

The metallic lithium plate is preferably a metallic lithium foil or metallic lithium coated on a conductive substrate, which are identical to those in the first embodiment.

The negative electrode tab may be a metal foil or a metal foam. The negative electrode tab may be composed of, but is not limited to, nickel, copper, iron, stainless steel, and so on. The surface area of the negative electrode tab contacting the metallic lithium plate is increased by 10%, preferably by 50 to 100% compared to the geographical area. The term “geographical area” is intended to mean a surface area of the negative electrode tab without the surface roughness, in other words a surface area supposing the surface is completely flat. In order to increase the contact of the negative electrode tab, the average surface roughness must be controlled. The average surface roughness of the area of negative electrode tab contacting the metallic lithium plate is preferably 0.1 to 5 μm, and more preferably 0.3 to 0.6 μm. When the roughness is less than 0.1 μm, the tab cannot be firmly attached to the metallic lithium plate, and when the roughness is more than 5 μm, the tab can be more easily broken or disconnected.

When the negative electrode tab is firmly attached to the metallic lithium plate, it is possible to provide a battery having a high capacity since the internal resistance is decreased upon the charge and discharge of the battery. In addition, the type of battery is not limited thereto since it is easy to attach the negative electrode tab to the metallic lithium plate.

The negative electrode for a lithium battery according to the present invention can be employed in any lithium battery. Particularly, it can be employed in a lithium-sulfur battery having a positive active material of a sulfuric material. The lithium-sulfur battery comprises: a negative electrode according to any one of the first to the fourth embodiments; a positive electrode comprising a positive active material selected from the group consisting of elemental sulfur, Li₂Sₙ (n≧1), Li₂Sₙ (n≧1) dissolved in a catholyte, an organosulfur compound, and a carbon-sulfur polymer ((C₂Sₓ)ₙ: x=2.5 to 50, n≧2); and an electrolyte.

The electrolyte may be either a solid electrolyte or a liquid electrolyte.

The solid electrolyte can function as both a separator and a medium capable of transporting metal ions, and it can be composed of any ionic conductive material that is electrochemically stable. The ionic conductive material may include a glass electrolyte, a polymer electrolyte, or a ceramic electrolyte. The preferred solid electrolyte may be formed by adding an appropriate supporting electrolyte to a polymer electrolyte such as polyether, polyimine, polythioether, and so on. The solid electrolyte separator may comprise less than about 20% by weight of a non-aqueous organic solvent. In this case, it can further comprise a suitable gelling agent to reduce the fluidity of the organic solvent.

When the electrolyte is a liquid electrolyte, the lithium-sulfur battery should further comprise a separator composed of porous glass, plastic, ceramic, or a polymer in order to physically separate the electrodes. The liquid electrode comprises a non-aqueous organic solvent and an electrolyte salt. The organic solvent may include a commonly used non-aqueous organic electrolyte such as ethylenecarbonate, propylenecarbonate, dioxolane, sulfolane, xylene, diglyme, tetrahydrofurane, tetraglyme, and so on.

The electrolyte salt may include a lithium cation-consisting lithium salt, an organic cation-consisting salt, or a mixture thereof.

The example of a lithium salt may include, but is not limited to, LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) (wherein x and y are natural numbers), LiCl, Lil, and so on.

The organic cation-consisting salt has a low vapor pressure, a very high flash point, and anti-combustibility, rendering the battery safe and anti-corrosive, so that it can be formed as a mechanically stable film. The preferable salt may include a large organic cation having a van der Waals volume of more than 100³. The greater the van der Waals volume of such a cation, the less the lattice energy, thus reducing ion conductivity.

The organic cation-consisting salt can be present as a liquid phase in a wide range of temperatures. The organic cation-consisting salt is preferably present as a liquid phase at a temperature of less than 100° C., more preferably present as a liquid phase at a temperature of less than 50° C., and most preferably present as a liquid phase at a temperature of less than 25° C. It is to be understood that it can be present as a liquid phase at a different range of temperatures depending on the applied method.

The organic cation is preferably any cation of a heterocyclic compound. The hetero atom of the heterocyclic compound may be selected from the group consisting of N, O, S, or a combination thereof. The heterocyclic composition may have one to four heteroatoms, and preferably one or two heteroatoms. The cation of the heterocyclic compound includes a cation of the compound selected from the group consisting of pyridinium, pyridazinium, pyrimidinium, pyrazinium, imidazolium, pyrazolium, thiazolium, oxazolium, and triazolium, or a substitute thereof. It is preferable a cation of an imidazolium compound such as 1-ethyl-3-methylimidazolium (EMI), 1,2-dimethyl-3-propylimidazolium (DMPI), 1-butyl-3-methylimidazolium (BMI), and so on.

An anion to be bound with the cation may be any one among bis(perfluoroethylsulfonyl)imide (N(C₂F₅SO₂)₂⁻, Beti), bis(trifluoromethylsulfonyl)imide (N(CF₃SO₂)₂⁻, Im), tris(trifluoromethylsulfonylmethide (C(CF₃SO₂)₂′, Me), trifluoromethane sulfonamide, trifluoromethane sulfonimide, trifluoromethyl sulfonimide, trifluoromethyl sulfonate, AsF₆⁻, ClO₄⁻, PF₆⁻, BF₄⁻, and so on.

The preferable example of the organic cation-containing salt includes 1-ethyl-3-methylimidazolium bis(perfluoroethyl sulfonyl)imide (EMIBeti), 1,2-dimethyl-3-propylimidazolium bis(trifluoromethyl sulfonyl)imide (DMPIIm), or 1-butyl-3-methylimidazolium hexafluorophosphate (BMIPF₆).

Hereinafter, the present invention will be explained in detail with reference to examples. These examples, however, should not in any sense be interpreted as limiting the scope of the present invention.

### EXAMPLE 1

75 wt. % of sulfur powder as a positive active material, 12 wt. % of polyethylene oxide (PEO) as a binder, and 13 wt. % of ketjen black as a conductive material were added to and uniformly dispersed with acetonitrile to prepare a slurry positive active material. The uniformly dispersed slurry was coated on a carbon-coated Al foil using a doctor blade to provide a positive electrode. Then, the positive electrode was cut into figures having a size of 22 cm² and Al tabs were welded thereto to prepare a positive electrode plate.

200 μm thick lithium metal foil was cut into figures having a size of 3×3 Cm² and a part of the foil was rubbed three times with a brush in order to impart a roughness to the surface thereof. The average surface roughness of the metallic lithium foil was 0.5 μm, determined using an optical 3D profiling system (Model No. NT2000, fabricated by WYKO). 10 μm thick copper foil was positioned on the surface of the lithium metal foil treated to have the average surface roughness, and it was then pressed with a pressure of about 0.3 tons to obtain a negative electrode plate.

The obtained positive electrode plate, a vacuum-dried polyethylene separator, and the obtained negative electrode plate were subsequently stacked and inserted into a pouch. An electrolyte of 1 M LiN(CF₃SO₂) in 1,3-dioxolane/dimethoxyethane/diglyme (2:4:4 volume ratio) was injected therein, and the pouch was sealed to complete a pouch-type test-cell.

### EXAMPLE 2

A test cell was fabricated by the same procedure as described in Example 1 except that the negative electrode plate was fabricated by cutting 200 μm thick lithium metal foil into figures having a size of 3×3 cm², stacking a 100 μm thick nickel foam having 85% porosity on the lithium foil, and pressing them at about 0.3 tons.

### EXAMPLE 3

A test cell was fabricated by the same procedure as described in Example 1 except that the negative electrode plate was fabricated by cutting 200 μm thick lithium metal foil into figures having a size of 3×3 cm², stacking 10 μm thick copper foils on both surfaces of the lithium foil, and welding them.

### COMPARATIVE EXAMPLE 1

A test cell was fabricated by the same procedure as described in Example 1 except that the negative electrode plate was fabricated by cutting 200 μm thick lithium metal foil into a size of 3×3 cm², stacking 100 μm thick nickel tab on the lithium foil, and pressing them.

30 test cells for each of Examples 1 to 3 and Comparative Example 1 were fabricated and the internal resistance (IR) and open circuit voltage (OCV) were measured. The results are shown in Table 1. IR and OCV were determined using a model 3550 (fabricated by HIOKI E.E. Corporation).

TABLE 1

| | | | | | | | Comparative | |
|---|---|---|---|---|---|---|---|---|
| | Example 1 | | Example 2 | | Example 3 | | Example 1 | |
| | IR(Ω) | OCV | IR(Ω) | OCV | IR(Ω) | OCV | IR(Ω) | OCV |
| 1 | 5.4 | 3.20 | 9.3 | 3.23 | 8.3 | 3.22 | off | 3.20 |
| 2 | 5.8 | 3.21 | 8.9 | 3.19 | 9.0 | 3.22 | 24 | 3.24 |
| 3 | 5.5 | 3.20 | 8.5 | 3.21 | 9.7 | 3.20 | 26 | 3.20 |
| 4 | 5.3 | 3.20 | 8.8 | 3.22 | 16.0 | 3.22 | 27 | 3.20 |
| 5 | 4.8 | 3.20 | 10.9 | 3.04 | 7.8 | 3.22 | 15 | 3.22 |
| 6 | 5 | 3.20 | 10.0 | 3.17 | 11.4 | 3.20 | off | 3.13 |
| 7 | 5.5 | 3.22 | 9.2 | 3.12 | 16.0 | 3.21 | 25 | 3.23 |
| 8 | 5.5 | 3.20 | 11.7 | 3.18 | 15.0 | 3.23 | 23 | 3.22 |
| 9 | 5.3 | 3.20 | 6.8 | 3.22 | 10.0 | 3.26 | 27 | 3.17 |
| 10 | 6.2 | 3.20 | 10.5 | 3.21 | 9.6 | 3.25 | off | 3.18 |
| 11 | 4.3 | 3.20 | 12.5 | 3.17 | 9.2 | 3.16 | 23 | 3.19 |
| 12 | 4.0 | 3.20 | 10.3 | 3.21 | 9.5 | 3.16 | 22 | 3.19 |
| 13 | 3.9 | 3.20 | 15.0 | 3.22 | 11.6 | 3.18 | 17 | 3.19 |
| 14 | 4.5 | 3.20 | 11.1 | 3.20 | 10.7 | 3.14 | 25 | 3.21 |
| 15 | 2.8 | 3.20 | 7.7 | 3.22 | 9.9 | 3.12 | off | 3.17 |
| 16 | 4.6 | 3.20 | 7.0 | 3.22 | 12.4 | 3.18 | off | 3.17 |
| 17 | 4.7 | 3.20 | 11.3 | 3.20 | 7.5 | 3.22 | off | 3.21 |
| 18 | 4.2 | 3.20 | 8.5 | 3.21 | 11.2 | 3.21 | 29 | 3.20 |
| 19 | 4.0 | 3.21 | 9.2 | 3.23 | 13.2 | 3.17 | 24 | 3.24 |
| 20 | 4.2 | 3.20 | 15.0 | 3.26 | 11.0 | 3.21 | 22 | 3.20 |
| 21 | 5.2 | 3.20 | 7.3 | 3.25 | 9.6 | 3.19 | 26 | 3.20 |
| 22 | 4.5 | 3.20 | 10.9 | 3.16 | 12.5 | 3.23 | 24 | 3.22 |
| 23 | 4.3 | 3.20 | 15.5 | 3.23 | 11.3 | 3.19 | 28 | 3.18 |
| 24 | 4.2 | 3.20 | 14.5 | 3.26 | 12.0 | 3.21 | 29 | 3.15 |
| 25 | 4.8 | 3.20 | 9.5 | 3.25 | 8.6 | 3.22 | off | 3.22 |
| 26 | 4.5 | 3.20 | 9.1 | 3.16 | 7.9 | 3.04 | 25 | 3.17 |
| 27 | 4.8 | 3.20 | 8.7 | 3.16 | 12.2 | 3.17 | 26 | 3.18 |
| 28 | 4.7 | 3.20 | 9.0 | 3.18 | 9.4 | 3.17 | 23 | 3.18 |
| 29 | 5.2 | 3.20 | 11.1 | 3.18 | 9.5 | 3.16 | off | 3.21 |
| 30 | 4.8 | 3.20 | 10.2 | 3.18 | 9.0 | 3.12 | off | 3.20 |

Note:
the indication “off” means the internal resistance is more than 30 Ω.

As shown in Table 1, the internal resistance of test cells of Examples 1 to 3 according to the present invention was significantly lower than those of Comparative Example 1. Since an increased internal resistance indicates an unstable contact between the tab and the electrode, it is advantageous to have the low internal resistance exhibited by the test cells of Examples 1 to 3 of the present invention, thus indicating a stable contact exists between the negative electrode and the negative electrode tab.

The negative electrode for a lithium battery according to the present invention can reduce the internal resistance upon charge and discharge of the battery due to the firm attachment between the metallic lithium plate and the negative electrode tab. A decrease of capacity is thereby prevented by decreasing the internal resistance, making it is possible to provide a high capacity battery. Further, it facilitates attaching the negative electrode tab to the metal lithium plate so that the type of the battery to be fabricated is not limited, and the occurrence of shorts is reduced.

Although a few embodiments of the present invention have been shown and described, it would be appreciated by those skilled in the art that changes may be made in this embodiment without departing from the principles and spirit of the invention, the scope of which is defined in the claims and their equivalents.

1. A negative electrode for a lithium battery, comprising:
a metallic lithium plate; and
a negative electrode tab attached to a surface of the metallic lithium plate,
wherein an average surface roughness of the metallic lithium plate on an area attached to the negative tab is 0.1 to 5 μm.

2. The negative electrode for a lithium battery according to claim 1, wherein the average surface roughness is 0.3 to 0.6 μm.

3. The negative electrode for a lithium battery according to claim 1, wherein the metallic lithium plate is a metallic lithium foil.

4. The negative electrode for a lithium battery according to claim 1, wherein the metallic lithium plate is a metallic lithium coated on a conductive substrate.

5. The negative electrode for a lithium battery according to claim 4, wherein the conductive substrate is selected from the group consisting of a metal foil, a metal film, a conductive polymer film, and a polymer film deposited with a metal.

6. The negative electrode for a lithium battery according to claim 1, wherein the negative electrode tab is a 10 to 50 μm thick metal plate.

7. The negative electrode for a lithium battery according to claim 1, wherein the negative electrode tab is a 10 to 50 μm thick metal foam.

8. The negative electrode for a lithium battery according to claim 1, wherein the negative electrode tab is made of at least one metal selected from the group consisting of nickel, copper, iron, and stainless steel.

9. A negative electrode for a lithium battery, comprising:
a metallic lithium plate; and
a negative electrode tab attached to the metallic lithium plate,
wherein the negative electrode tab has a porosity of 50 to 100%.

10. The negative electrode for a lithium battery according to claim 9, wherein the metallic lithium plate is a metallic lithium foil.

11. The negative electrode for a lithium battery according to claim 9, wherein the metallic lithium plate is a metallic lithium coated on a conductive substrate.

12. The negative electrode for a lithium battery according to claim 11, wherein the conductive substrate is selected from the group consisting of a metal foil, a metal film, a conductive polymer film, and a polymer film deposited with a metal.

13. The negative electrode for a lithium battery according to claim 9, wherein the negative electrode tab is composed of at least one metal selected from the group consisting of nickel, copper, iron, and stainless steel.

14. The negative electrode for a lithium battery according to claim 9, wherein the porosity of the negative electrode tab is 80 to 95%.

15. A negative electrode for a lithium battery, comprising:
a metallic lithium plate; and
a negative electrode tab attached to an upper and a lower end surfaces of the metallic lithium plate.

16. The negative electrode for a lithium battery according to claim 15, wherein the metallic lithium plate is a metallic lithium foil.

17. The negative electrode for a lithium battery according to claim 15, wherein the metallic lithium plate is a metallic lithium coated on a conductive substrate.

18. The negative electrode for a lithium battery according to claim 17, wherein the conductive substrate is selected from the group consisting of a metal foil, a metal film, a conductive polymer film, and a polymer film deposited with a metal.

19. The negative electrode for a lithium battery according to claim 15, wherein the negative electrode tab is made of at least one metal selected from the group consisting of nickel, copper, iron, and stainless steel.

20. A negative electrode for a lithium battery comprising:
a metallic lithium plate; and
a negative electrode tab attached to a surface of metallic lithium plate,
wherein a surface of the negative electrode tab that is attached to the metallic lithium plate has a surface area of 10% larger than a geographical area.

21. The negative electrode for a lithium battery according to claim 20, wherein the metallic lithium plate is a metallic lithium foil.

22. The negative electrode for a lithium battery according to claim 20, wherein the metallic lithium plate is a metallic lithium coated on a conductive substrate.

23. The negative electrode for a lithium battery according to claim 22, wherein the conductive substrate is selected from the group consisting of a metal foil, a metal film, a conductive polymer film, and a polymer film deposited with a metal.

24. The negative electrode for a lithium battery according to claim 20, wherein the negative electrode tab is made of at least one metal selected from the group consisting of nickel, copper, iron, and stainless steel.

25. A negative electrode for a lithium battery according to claim 20, wherein a surface area contacting the metallic lithium plate of the negative electrode tab is increased by 50 to 100% compared to the geographical area.

26. A method of fabricating a negative electrode for a lithium battery, comprising:
brushing the surface area of a metallic lithium plate to be attached to a negative electrode tab so that an average surface roughness of a surface area (Ra) is 0.1 to 5 μm; and
pressing the negative electrode tab onto the metallic lithium plate and attaching the negative electrode tab to the metallic lithium plate.

27. A lithium battery comprising;
a negative electrode;
a positive electrode; and
an electrolyte,
wherein the negative electrode further comprises a metallic lithium plate and a negative electrode tab attached to a surface of the metallic lithium plate, wherein an average surface roughness of the metallic lithium plate on an area attached to the negative tab is 0.1 to 5 μm.

28. A lithium-sulfur battery comprising:
a negative electrode comprising a metallic lithium plate and a negative tab attached to a surface of the metallic lithium plate, wherein the average surface roughness of the metallic lithium plate on an area attached to the negative tab is 0.1 to 5 μm, and
a positive electrode comprising a positive active material selected from the group consisting of elemental sulfur, Li₂Sₙ(n≧1), Li₂Sₙ(n≧1) dissolved in a catholyte, an organosulfur compound, and a carbon-sulfur polymer ((C₂Sₓ)ₙ: x=2.5 to 50, n≧2), and
an electrolyte.
